(19) United States
(12) Patent Application Publication
(10) Pub. No.: US 2019/0042364 A1
(43) Pub. Date: Feb. 7, 2019

(54) TECHNOLOGIES FOR MAINTAINING DATA INTEGRITY DURING DATA TRANSMISSIONS

(71) Applicant: Intel Corporation, Santa Clara, CA (US)

(72) Inventors: Samantha Edirisooriya, Tempe, AZ (US); Robert Papp, Chandler, AZ (US)

(21) Appl. No.: 16/017,684

(22) Filed: Jun. 25, 2018

(51) Int. Cl. G06F 11/10; G06F 3/06

(52) U.S. Cl. CPC G06F 11/1076; G06F 3/0673; G06F 3/064; G06F 3/0619

(57) ABSTRACT

Technologies for maintaining integrity of requested data include data communicator circuitry and data integrity manager circuitry. The data communicator circuitry is configured to communicate a memory access request from a processor of the compute device to a memory of the compute device, obtain data associated with the memory access request from a data source via a communication channel, and obtain error control data associated with the data from the data source via an available communication channel that is different from the communication channel, wherein the data source is configured to provide requested data associated with the memory access request. The data integrity manager circuitry is configured to determine an integrity of the obtained data from the data source. In response to a determination that the obtained data includes an error, the data integrity manager is configured to correct the obtained data to generate corrected data.

### BACKGROUND

Data stored in a memory device may be protected from corruption during data transmissions. For example, error detection (e.g., parity) may be used to detect errors in a memory system during data transmission. The data may be transferred to a memory device with an associated byte parity data which may have been generated by a data source. Parity logic may compute byte parity of the transferred data and compare the computed byte parity data with the byte parity data received from the data source prior to storing the data in the memory device to ensure that no errors have been introduced to transferred or transmitted data. Additionally, when the data is read out of the memory device, the byte parity may again be computed and compared with the existing parity to ensure that no errors have been introduced to the stored data. However, since byte parity cannot correct any single bit errors, a single bit link error during the data transmissions may generate an uncorrectable error.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a compute device that includes a memory controller for maintaining data integrity during data transmissions by detecting and correcting bit errors that may occur during the data transmissions;

FIG. 2 is a simplified block diagram of at least one embodiment of an environment that may be established by the memory controller of FIG. 1; and

FIGS. 3 and 4 are a simplified flow diagram of at least one embodiment of a method for maintaining data integrity during data transmissions that may be executed by the memory controller of the compute device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

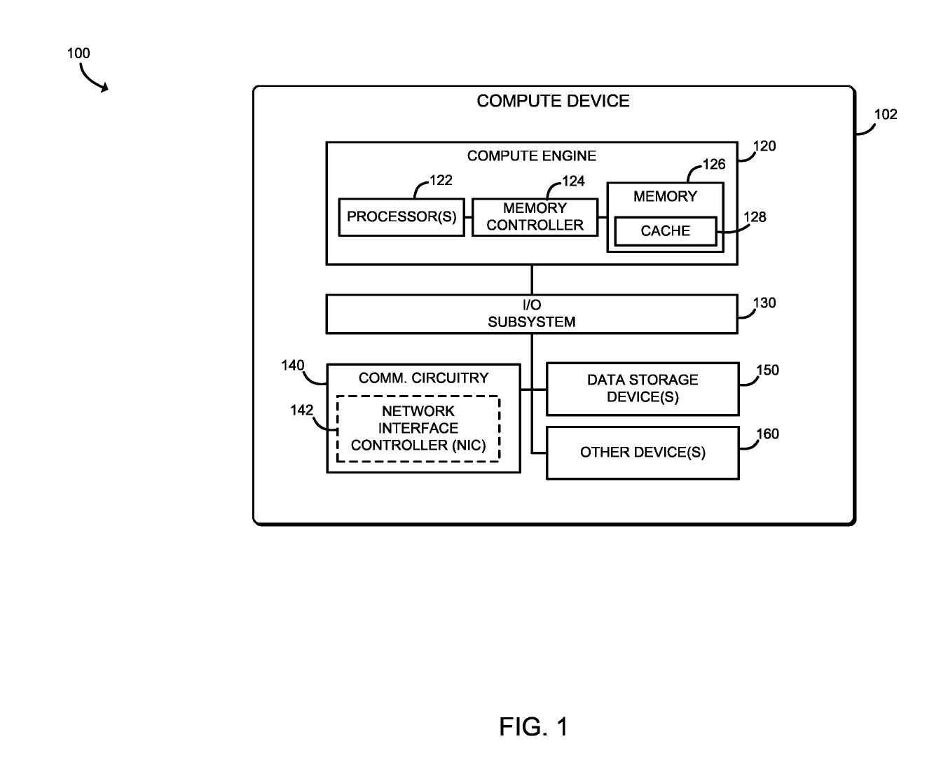

Referring now to FIG. 1, an illustrative system 100 for maintaining data integrity during data transmissions includes a compute device 102 having a compute engine 120. The compute engine 120 further includes one or more processor(s) 122, a memory controller 124, and a memory 126. In use, the memory controller 124 may be configured to communicatively link the one or more processor(s) 122 and the memory 126 to detect and correct bit errors that may occur during the data transmissions. To do so, the memory controller 124 may receive a memory access request to read data from the memory 126 or write data to the memory 126. In response, the memory controller 124 may obtain requested data associated with the memory access request from a data source along with parity data and error correcting code (ECC) data associated with the requested data without adding any memory interface signals or link latencies. In the illustrative embodiment, the parity data may be computed across two bytes using a single parity bit and the ECC data may be generated across either a cache line (e.g., 64 Bytes) or a half a cache line (e.g., 32 Bytes) serially by the data source. It should be appreciated that the parity data and the ECC data are obtained via different communication channels, which are different from a communication used to transmit the requested data. Subsequent to a receipt of the requested data, the memory controller 124 may compute parity and compare the computed parity with the parity data obtained from the data source to detect one or more errors during data transmission and use the ECC to correct data. In some embodiments, if there are no parity errors, ECC may still be used detect certain errors (e.g., even number of bit errors, multi-bit errors) that may have escaped the error detection mechanism.

The compute device 102 may be embodied as any type of computation or compute device capable of performing the functions described herein, including, without limitation, a computer, a desktop computer, a smartphone, a workstation, a laptop computer, a notebook computer, a tablet computer, a mobile compute device, a wearable compute device, a network appliance, a web appliance, a distributed computing system, a processor-based system, and/or a consumer electronic device. As shown in FIG. 1, the illustrative compute device 102 includes the compute engine 120, an input/output (I/O) subsystem 130, communication circuitry 140, one or more data storage devices 150, and one or more other devices 160. Additionally, in some embodiments, one or more of the illustrative components may be incorporated in, or otherwise form a portion of, another component.

The compute engine 120 may be embodied as any type of device or collection of devices capable of performing various compute functions described below. In the illustrative embodiment, the compute engine 120 is configured to detect errors during data transmissions and correct the errors to maintain integrity of the data being transferred (e.g., within the compute engine 120). In some embodiments, the compute engine 120 may be embodied as a single device such as an integrated circuit, an embedded system, a field-programmable gate array (FPGA), a system-on-a-chip (SoC), or other integrated system or device. As discussed above, in the illustrative embodiment, the compute engine 120 includes the one or more processors 122, the memory controller 124, and the memory 126. The processor 122 may be embodied as any type of processor capable of performing the functions described herein. For example, the processor 122 may be embodied as a single or multi-core processor(s), a microcontroller, or other processor or processing/controlling circuit. In some embodiments, the processor 122 may be embodied as, include, or be coupled to an FPGA, an application specific integrated circuit (ASIC), reconfigurable hardware or hardware circuitry, or other specialized hardware to facilitate performance of the functions described herein. In the illustrative embodiment, the processor 122 may generate a memory access request to read data from the memory 126 or write data to the memory 126.

The memory controller 124 may be embodied as any type of device or collection of devices capable of performing various compute functions described herein. As discussed above, in the illustrative embodiment, the memory controller 124 is configured to communicatively link the one or more processor(s) 122 and the memory 126 to detect and correct bit errors that may occur during the data transmissions. It should be appreciated that, in some embodiments, the memory controller 124 may be embodied as part of the one or more processors 122 or the memory 126 (e.g., cache memory 128).

The memory 126 may be embodied as any type of volatile (e.g., dynamic random access memory (DRAM), cache memory, etc.) or non-volatile memory or data storage capable of performing the functions described herein. Cache memory or volatile memory 128 may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include other nonvolatile devices, such as a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In the illustrative embodiment, the memory includes static random access memory (SRAM).

The compute engine 120 is communicatively coupled to other components of the compute device 102 via the I/O subsystem 130, which may be embodied as circuitry and/or components to facilitate input/output operations with the compute engine 120 (e.g., with the processor 122 and/or the memory 126) and other components of the compute device 102. For example, the I/O subsystem 130 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 130 may form a portion of a system-on-a-chip (SoC) and be incorporated, along with one or more of the processor 122, the memory 126, and other components of the compute device 102, into the compute engine 120.

The communication circuitry 140 may be embodied as any communication circuit, device, or collection thereof, capable of enabling communications between the compute device 102 and another compute device. The communication circuitry 140 may be configured to use any one or more communication technology (e.g., wired or wireless communications) and associated protocols (e.g., Ethernet, Bluetooth®, Wi-Fi®, WiMAX, etc.) to effect such communication. The communication circuitry 140 may include a network interface controller (NIC) 142 (e.g., as an add-in device), which may also be referred to as a port logic. The NIC 142 may be embodied as one or more add-in-boards, daughter cards, network interface cards, controller chips, chipsets, or other devices that may be used by the compute device 102 to connect with another compute device. In some embodiments, the NIC 142 may be embodied as part of a system-on-a-chip (SoC) that includes one or more processors, or included on a multichip package that also contains one or more processors. In some embodiments, the NIC 142 may include a local processor (not shown) and/or a local memory (not shown) that are both local to the NIC 142. In such embodiments, the local processor of the NIC 142 may be capable of performing one or more of the functions of the compute engine 120 described herein. Additionally or alternatively, in such embodiments, the local memory of the NIC 142 may be integrated into one or more components of the compute device 102 at the board level, socket level, chip level, and/or other levels.

The one or more illustrative data storage devices 150 may be embodied as any type of devices configured for short-term or long-term storage of data such as, for example, memory devices and circuits, memory cards, hard disk drives, solid-state drives, or other data storage devices. Each data storage device 150 may include a system partition that stores data and firmware code for the data storage device 150. Each data storage device 150 may also include one or more operating system partitions that store data files and executables for operating systems. The one or more illustrative other devices 160 may be other or additional components, such as those commonly found in a computer (e.g., peripheral devices).

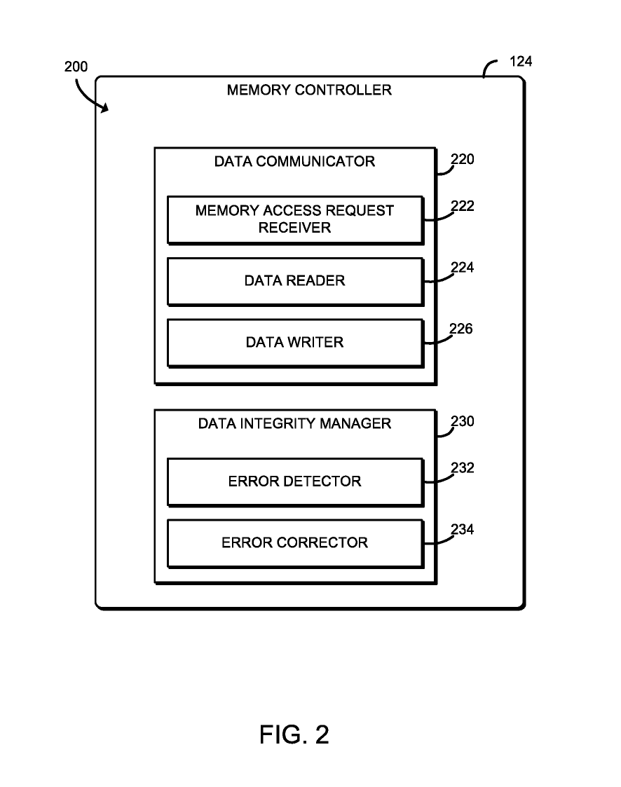

Referring now to FIG. 2, in the illustrative embodiment, the compute device 102 may establish an environment 200 during operation. The illustrative environment 200 includes a data communicator 220 and a data integrity manager 230. The data communicator 220 further includes a memory access request receiver 222, a data reader 224, and a data writer 226. Additionally, the data integrity manager 230 further includes an error detector 232 and an error corrector 234. Each of the components of the environment 200 may be embodied as hardware, firmware, software, or a combination thereof. As such, in some embodiments, one or more of the components of the environment 200 may be embodied as circuitry or a collection of electrical devices (e.g., data communicator circuitry 220, memory access request receiver circuitry 222, data reader circuitry 224, data writer circuitry 226, data integrity manager circuitry 230, error detector circuitry 232, error corrector circuitry 234, etc.). It should be appreciated that, in such embodiments, one or more of the data communicator circuitry 220, the memory access request receiver circuitry 222, the data reader circuitry 224, the data writer circuitry 226, the data integrity manager circuitry 230, the error detector circuitry 232, and/or the error corrector circuitry 234 may form a portion of the compute engine 120 (e.g., one or more of the processor(s) 122, the memory controller 124, the memory 126, and the cache 128).

The data communicator 220, which may be embodied as hardware, firmware, software, virtualized hardware, emulated architecture, and/or a combination thereof as discussed above, is configured to monitor signal communication between the one or more processors 122 and the memory 126. Specifically, the data communicator 220 includes the memory access request receiver 222 that is configured to configured to receive a data access request from the processor(s) 122 and determine whether the data access request to read requested data from a specific memory address of the memory 126 or write requested data received from the processor(s) 122 to a specific memory address of the memory 126.

Additionally, the data communicator 220 is further configured to perform data operations associated with the memory access request by communicating between a data source where requested data is obtained from and a destination where the requested data is transmitted to. To do so, the data communicator 220 further includes the data reader 224 and the data writer 226. It should be appreciated that, in the illustrative embodiment, the data source is configured to provide data associated with a memory access request, and the destination is configured to receive the data. It should be noted that the data source and the destination depend on a type of a memory access request received from the processor(s) 122. For example, if the memory access request is a data read request from the memory 126, the memory 126 is the data source and the processor(s) 122 is the destination. Alternatively, if the memory access request is a data write request to the memory 126, the processor(s) 122 is the data source and the memory 126 is the destination.

The memory access request receiver 222 is configured to receive a data access request from the processor(s) 122 and determine whether the data access request to read requested data from a specific memory address of the memory 126 or write requested data received from the processor(s) 122 to a specific memory address of the memory 126. Additionally, the data reader 224 is configured to read data from a particular memory address of the memory 126 associated with a data access request in response to a determination that the data access request is a data read request. Similarly, the data writer 226 is configured to write requested data received from the processor(s) 122 to the memory 126 in response to a determination that the data access request is a data write request.

The data integrity manager 230, which may be embodied as hardware, firmware, software, virtualized hardware, emulated architecture, and/or a combination thereof as discussed above, is configured to manage integrity of data transmitted between the data source and the destination of requested data associated with the data access request. Moreover, the data integrity manager 230 is further configured to obtain parity data associated with data obtained from the data source in order to detect errors in the obtained data and error correcting code (ECC) data associated with the data obtained from the data source to correct any errors detected in the obtained data. To do so, the data integrity manager 230 further includes the error detector 232 and the error corrector 234.

The error detector 232 is configured to detect errors in data obtained from a source device (e.g., the memory 126 if the data is transmitted in response to a data read request, or the processor(s) 122 if the data is transmitted in response to a data write request). To do so, the error detector 232 is configured to compute parity based on the obtained data and compare the computed parity with the parity obtained from the data source. If the computed parity and the obtained parity are different, the error detector 232 detects an error in the obtained data from the data source.

In response to detecting error(s) in the obtained data, the error corrector 234 is configured to correct the obtained data using the ECC obtained from the data source. For example, as discussed above, the ECC data may be computed across either a cache line (e.g., 64 Bytes) or a half a cache line (e.g., 32 Bytes) serially. It should be appreciated that generating ECC across a half cache line may be faster compared to generating ECC data across a full cache line. This may decrease an overall transmission time. Additionally, in the embodiments in which the ECC data is computed across a half cache line, two half cache lines may be generated based on even and odd bits in the cache line to support error correction for two bit errors occurring in adjacent data lanes (i.e., multi-bit error correction by interleaving).

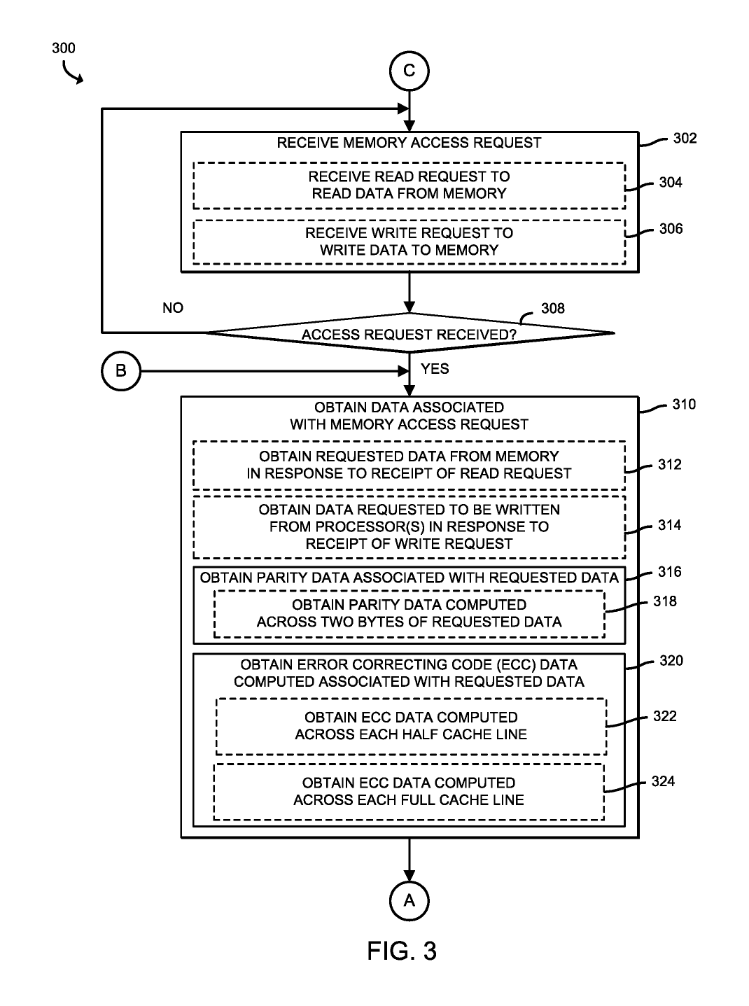

Referring now to FIG. 3, in use, the memory controller 124 may execute a method 300 for maintaining data integrity during data transmissions (e.g., in the compute engine 120). The method 300 begins with block 302 in which the memory controller 124 receives a memory access request from the processor(s) 122. For example, the memory controller 124 may receive a read request from the processor(s) 122 to access the memory 126 to read requested data as indicated in block 304. Alternatively, the memory controller 124 may receive a write request from the processor(s) 122 to access the memory 126 to write requested data as indicated in block 306.

In block 308, if the memory controller 124 determines that a memory access request has been not been received, the method 300 loops back to block 302 to continue monitoring for a receipt of a memory access request. If, however, the memory controller 124 determines that a memory access request has been received, the method 300 advances to block 310.

In block 310, the memory controller 124 obtains requested data associated with the memory access request. For example, if the memory access request is a read request, the memory controller 124 may obtain requested data from the memory 126 in response to a receipt of the read request from the processor(s) 122 as indicated in block 312. Alternatively, if the memory access request is a write request, the memory controller 124 may obtain data requested to be written in the memory 126 from the processor(s) 122 in response to a receipt of the write request as indicated in block 314.

Regardless of whether the received memory access request is to read or write data from or to the memory 126, respectively, parity data associated with the requested data is as indicated in block 316. In some embodiments, the parity data includes a plurality of parity bits, each of which is computed across two bytes of the requested data as indicated in block 318.

Similarly, regardless of whether the received memory access request is to read or write data from or to the memory 126, respectively, error correcting code (ECC) data associated with the requested data is also obtained as indicated in block 320. For example, in some embodiments, the obtained ECC data may be computed across each half cache line as indicated in block 322 or each full cache line as indicated in block 324.

In the illustrative embodiment, the parity and ECC data are transmitted to the memory controller 124 via communication channels that are different from a communication channel that is used to transmit the requested data. It should be appreciated that the parity data and the ECC data are transmitted serially via different channels. For example, some communication channels that are used during data write requests to transmit data may be unused during read requests, and some communication channels that are used during data read requests may be unused during write requests. As such, the compute engine 120 may utilize one or more of unused communication channels during memory access requests to increase resource utilization/efficiency. Specifically, if the memory access request is a read request, communication channels that are designated for write requests may be used to transmit the parity data and the ECC data associated with the requested data. In such examples, the memory controller 124 obtains the parity data and the ECC data associated with the requested data and computed by the memory 126 in order to evaluate the integrity of the data obtained from the memory 126. Likewise, if the memory access request is a write request, communication channels that are designated for read requests may be used to transmit the parity data and the ECC data associated with the requested data. In such examples, the memory controller 124 may obtain the parity data and the ECC data associated with the requested data that are computed by the processor(s) 122 in order to evaluate the integrity of the data obtained from the memory 126.

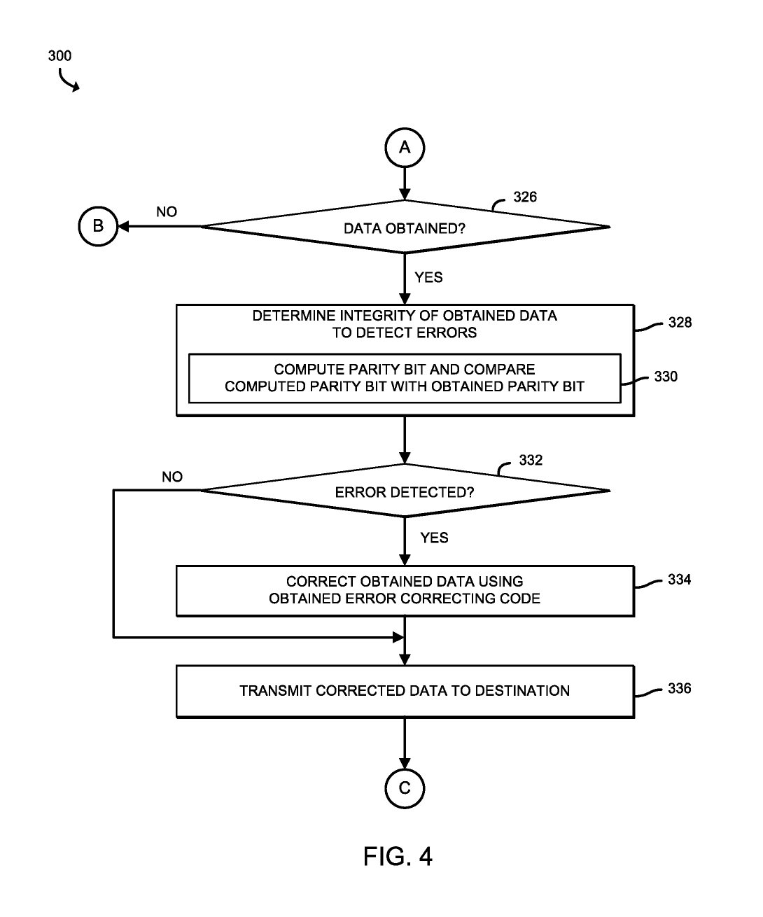

Subsequent to obtaining the data associated with the memory access request, the parity data, and the ECC data, the method 300 advances to block 326 shown in FIG. 4. In block 326, the memory controller 124 verifies that the data has been obtained from a data source in response to transmitting the memory access request. If the memory controller 124 determines that the data has not been obtained, the method 300 loops back to block 310 to continue obtaining the data associated with the memory access request. However, if the memory controller 124 determines that the data has been obtained, the method 300 advances to block 328.

In block 328, the memory controller 124 determines the integrity of the obtained data. To do so, the memory controller 124 computes a parity bit based on the obtained data and compares the computed parity with the obtained parity bit of the parity data as indicated in block 330. As discussed above, the parity data include a plurality of parity bits computed across two bytes of data.

In block 332, the memory controller 124 determines whether an error has been detected. To do so, the memory controller 124 determines whether the computed parity and the obtained parity data are the same. If the memory controller 124 determines that an error has not been detected (e.g., the computed parity and the parity data match), the method 300 skips ahead to block 336, in which the memory controller 124 transmits the obtained data to the destination. If, however, the memory controller 124 determines that an error has been detected (e.g., the computed parity and the parity data do not match), the method 300 advances to block 334.

In block 334, the memory controller 124 corrects the obtained data using the obtained ECC data. In some embodiments, the ECC data may be redundant data that has been added to the requested data such that the requested data can be recovered by the memory controller 124 even when one or more errors were introduced during the data transmission. As discussed above, the ECC data allows the memory controller 124 to correct a single bit error to multi-bit errors.

Subsequently, in block 336, the memory controller 124 transmits the corrected data to its destination. For example, if the memory access request is a read request, the memory controller 124 transmits the corrected data to the processor(s) 122 that requested the read request. Alternatively, if the memory access request is a write request, the memory controller 124 transmits the corrected data to the memory 126 such that the corrected data may be stored in the memory 126. The method 300 then loops back to block 302 to continue monitoring for a receipt of a memory access request from the processor(s) 122.

### EXAMPLES

Illustrative examples of the technologies disclosed herein are provided below. An embodiment of the technologies may include any one or more, and any combination of, the examples described below.

Example 1 includes a compute device for maintaining integrity of requested data, the compute device comprising data communicator circuitry to (i) communicate a memory access request from a processor of the compute device to a memory of the compute device, (ii) obtain requested data associated with the memory access request from a data source via a communication channel, and (iii) obtain error control data associated with the requested data from the data source via an available communication channel that is different from the communication channel, wherein the data source is configured to provide the requested data associated with the memory access request; and data integrity manager circuitry to determine an integrity of the obtained data from the data source and correct, in response to a determination that the obtained data includes an error, the obtained data to generate corrected data, wherein the data communicator circuitry is further to transmit the corrected data to a destination.

Example 2 includes the subject matter of Example 1, and wherein the memory access request is a read request, the data source is the memory, and the destination is the processor.

Example 3 includes the subject matter of any of Examples 1 and 2, and wherein the memory access request is a write request, the data source is the processor, and the destination is the memory.

Example 4 includes the subject matter of any of Examples 1-3, and wherein to correct the obtained data comprises to correct a bit error or multi-bit errors of the obtained data.

Example 5 includes the subject matter of any of Examples 1-4, and wherein the error control data includes parity data associated with the requested data, and to determine the integrity of the obtained data from the data source comprises to compute parity based on the obtained data and compare the computed parity with obtained parity data to detect an error.

Example 6 includes the subject matter of any of Examples 1-5, and wherein the parity data is determined across two bytes of the requested data.

Example 7 includes the subject matter of any of Examples 1-6, and wherein the error control data includes error correcting code (ECC) data associated with the requested data, and to correct the obtained data comprises to correct, in response to a detection of the error of the obtained data, the obtained data based on the ECC data.

Example 8 includes the subject matter of any of Examples 1-7, and wherein the ECC data is determined across half of a cache line or across a cache line.

Example 9 includes the subject matter of any of Examples 1-8, and wherein the obtained parity data and the obtained ECC data are computed by the data source and transmitted via a first available communication channel and a second available communication channel, respectively, that are different from the communication channel used to obtain the obtained data from the data source, wherein the first and second available communication channels are communication channels that are being unused during the data transmission.

Example 10 includes a method for maintaining integrity of requested data, the method comprising communicating, by a compute device, a memory access request from a processor of the compute device to a memory of the compute device via a communication channel; obtaining, by the compute device, requested data associated with the memory access request from a data source via a communication channel, wherein the data source is configured to provide the requested data associated with the memory access request; obtain, by the compute device, error control data associated with the requested data from the data source via an available communication channel that is different from the communication channel; determining, by the compute device, an integrity of the obtained data from the data source; correcting, in response to a determination that the obtained data includes an error, the obtained data to generate corrected data; and transmitting, by the compute device, the corrected data to a destination.

Example 11 includes the subject matter of Example 10, and wherein the memory access request is a read request, the data source is the memory, and the destination is the processor.

Example 12 includes the subject matter of any of Examples 10 and 11, and wherein the memory access request is a write request, the data source is the processor, and the destination is the memory.

Example 13 includes the subject matter of any of Examples 10-12, and wherein correcting the obtained data comprises correcting a bit error or multi-bit errors of the obtained data.

Example 14 includes the subject matter of any of Examples 10-13, and wherein the error control data includes parity data associated with the requested data, and wherein determining integrity of the obtained data from the data source comprises computing parity based on the obtained data and comparing the computed parity with obtained parity data to detect an error.

Example 15 includes the subject matter of any of Examples 10-14, and wherein the parity data is determined across two bytes of the requested data.

Example 16 includes the subject matter of any of Examples 10-15, and wherein the error control data includes error correcting code (ECC) data associated with the requested data, and wherein correcting the obtained data comprises correcting, in response to a detection of the error of the obtained data, the obtained data based on the ECC data.

Example 17 includes the subject matter of any of Examples 10-16, and wherein the ECC data is determined across half of a cache line or across a cache line.

Example 18 includes the subject matter of any of Examples 10-17, and wherein the obtained parity data and the obtained ECC data are computed by the data source and transmitted via a first available communication channel and a second available communication channel, respectively, that are different from the communication channel used to obtain the obtained data from the data source, wherein the first and second available communication channels are communication channels that are being unused during the data transmission.

Example 19 includes one or more machine-readable storage media comprising a plurality of instructions stored thereon that, when executed, causes a compute device to communicate a memory access request from a processor of the compute device to a memory of the compute device via a communication channel; obtain requested data associated with the memory access request from a data source, wherein the data source is configured to provide the requested data associated with the memory access request; obtain error control data associated with the requested data from the data source via an available communication channel that is different from the communication channel; determine an integrity of the obtained data from the data source; correct, in response to a determination that the obtained data includes an error, the obtained data to generate corrected data; and transmit the corrected data to a destination.

Example 20 includes the subject matter of Example 19, and wherein the memory access request is a read request, the data source is the memory, and the destination is the processor.

Example 21 includes the subject matter of any of Examples 19 and 20, and wherein the memory access request is a write request, the data source is the processor, and the destination is the memory.

Example 22 includes the subject matter of any of Examples 19-21, and wherein to correct the obtained data comprises to correct a bit error or multi-bit errors of the obtained data.

Example 23 includes the subject matter of any of Examples 19-22, and wherein the error control data includes parity data associated with the requested data, and wherein to determine the integrity of the obtained data from the data source comprises to compute parity based on the obtained data and compare the computed parity with obtained parity data to detect an error.

Example 24 includes the subject matter of any of Examples 19-23, and wherein the error control data includes error correcting code (ECC) data associated with the requested data, and wherein to correct the obtained data comprises to correct, in response to a detection of the error of the obtained data, the obtained data based on the ECC data.

Example 25 includes the subject matter of any of Examples 19-24, and wherein the obtained parity data and the obtained ECC data are computed by the data source and transmitted via a first available communication channel and a second available communication channel, respectively, that are different from the communication channel used to obtain the obtained data from the data source, wherein the first and second available communication channels are communication channels that are being unused during the data transmission.

1. A compute device for maintaining integrity of requested data, the compute device comprising:
data communicator circuitry to (i) communicate a memory access request from a processor of the compute device to a memory of the compute device, (ii) obtain requested data associated with the memory access request from a data source via a communication channel, and (iii) obtain error control data associated with the requested data from the data source via an available communication channel that is different from the communication channel, wherein the data source is configured to provide the requested data associated with the memory access request; and
data integrity manager circuitry to determine an integrity of the obtained data from the data source and correct, in response to a determination that the obtained data includes an error, the obtained data to generate corrected data,
wherein the data communicator circuitry is further to transmit the corrected data to a destination.

2. The compute device of claim 1, wherein the memory access request is a read request, the data source is the memory, and the destination is the processor.

3. The compute device of claim 1, wherein the memory access request is a write request, the data source is the processor, and the destination is the memory.

4. The compute device of claim 1, wherein to correct the obtained data comprises to correct a bit error or multi-bit errors of the obtained data.

5. The compute device of claim 1, wherein the error control data includes parity data associated with the requested data, and to determine the integrity of the obtained data from the data source comprises to compute parity based on the obtained data and compare the computed parity with obtained parity data to detect an error.

6. The compute device of claim 5, wherein the parity data is determined across two bytes of the requested data.

7. The compute device of claim 5, wherein the error control data includes error correcting code (ECC) data associated with the requested data, and to correct the obtained data comprises to correct, in response to a detection of the error of the obtained data, the obtained data based on the ECC data.

8. The compute device of claim 7, wherein the ECC data is determined across half of a cache line or across a cache line.

9. The compute device of claim 6, wherein the obtained parity data and the obtained ECC data are computed by the data source and transmitted via a first available communication channel and a second available communication channel, respectively, that are different from the communication channel used to obtain the obtained data from the data source, wherein the first and second available communication channels are communication channels that are being unused during the data transmission.

10. A method for maintaining integrity of requested data, the method comprising:
communicating, by a compute device, a memory access request from a processor of the compute device to a memory of the compute device via a communication channel;
obtaining, by the compute device, requested data associated with the memory access request from a data source via a communication channel, wherein the data source is configured to provide the requested data associated with the memory access request;
obtain, by the compute device, error control data associated with the requested data from the data source via an available communication channel that is different from the communication channel;
determining, by the compute device, an integrity of the obtained data from the data source;
correcting, in response to a determination that the obtained data includes an error, the obtained data to generate corrected data; and
transmitting, by the compute device, the corrected data to a destination.

11. The method of claim 10, wherein the memory access request is a read request, the data source is the memory, and the destination is the processor.

12. The method of claim 10, wherein the memory access request is a write request, the data source is the processor, and the destination is the memory.

13. The method of claim 10, wherein correcting the obtained data comprises correcting a bit error or multi-bit errors of the obtained data.

14. The method of claim 10, wherein the error control data includes parity data associated with the requested data, and wherein determining integrity of the obtained data from the data source comprises computing parity based on the obtained data and comparing the computed parity with obtained parity data to detect an error.

15. The method of claim 14, wherein the parity data is determined across two bytes of the requested data.

16. The method of claim 14, wherein the error control data includes error correcting code (ECC) data associated with the requested data, and wherein correcting the obtained data comprises correcting, in response to a detection of the error of the obtained data, the obtained data based on the ECC data.

17. The method of claim 16, wherein the ECC data is determined across half of a cache line or across a cache line.

18. The method of claim 16, wherein the obtained parity data and the obtained ECC data are computed by the data source and transmitted via a first available communication channel and a second available communication channel, respectively, that are different from the communication channel used to obtain the obtained data from the data source, wherein the first and second available communication channels are communication channels that are being unused during the data transmission.

19. One or more machine-readable storage media comprising a plurality of instructions stored thereon that, when executed, causes a compute device to:
communicate a memory access request from a processor of the compute device to a memory of the compute device via a communication channel;
obtain requested data associated with the memory access request from a data source, wherein the data source is configured to provide the requested data associated with the memory access request;
obtain error control data associated with the requested data from the data source via an available communication channel that is different from the communication channel;
determine an integrity of the obtained data from the data source;
correct, in response to a determination that the obtained data includes an error, the obtained data to generate corrected data; and
transmit the corrected data to a destination.

20. The one or more computer-readable storage media of claim 19, wherein the memory access request is a read request, the data source is the memory, and the destination is the processor.

21. The one or more computer-readable storage media of claim 19, wherein the memory access request is a write request, the data source is the processor, and the destination is the memory.

22. The one or more computer-readable storage media of claim 19, wherein to correct the obtained data comprises to correct a bit error or multi-bit errors of the obtained data.

23. The one or more computer-readable storage media of claim 19, wherein the error control data includes parity data associated with the requested data, and wherein to determine the integrity of the obtained data from the data source comprises to compute parity based on the obtained data and compare the computed parity with obtained parity data to detect an error.

24. The one or more computer-readable storage media of claim 23, wherein the error control data includes error correcting code (ECC) data associated with the requested data, and wherein to correct the obtained data comprises to correct, in response to a detection of the error of the obtained data, the obtained data based on the ECC data.

25. The one or more computer-readable storage media of claim 24, wherein the obtained parity data and the obtained ECC data are computed by the data source and transmitted via a first available communication channel and a second available communication channel, respectively, that are different from the communication channel used to obtain the obtained data from the data source, wherein the first and second available communication channels are communication channels that are being unused during the data transmission.
